(19) United States
(12) Patent Application Publication
(10) Pub. No.: US 2012/0185103 A1
(43) Pub. Date: Jul. 19, 2012

(54) Method for Controlling Power Generating Equipment

(76) Inventors: David R. Blair, Munroe Falls, OH (US); David C. Smith, Columbiana, OH (US)

(21) Appl. No.: 13/348,992

(22) Filed: Jan. 12, 2012

Related U.S. Application Data
(60) Provisional application No. 61/461,118, filed on Jan. 13, 2011.

(51) Int. Cl. G06F 1/28

(52) U.S. Cl. 700/288

(57) ABSTRACT

A Method of controlling power generating equipment to coordinate with the demands of heating equipment and cooling equipment that are powered by exhaust gases from the power generating equipment.

A feed-forward prediction is produced of the electrical power supply that produces substantially the required exhaust gas output to match the heating and cooling equipment requirements.

A composite power production demand error variable is produced that combines all of the heating and cooling demand requirements that vary from the feed-forward prediction;

The demand error variable is sent to a proportional integral derivative control element to generate a control variable. The control variable and the feed-forward prediction are combined to produce a setting for the power generating equipment to produce essentially only the gases required to operate the heating equipment and cooling equipment at the desired level.

### CROSS REFERENCES

This application claims the benefit of provisional patent application No. 61/461,118 filed on Jan. 13, 2011.

### BACKGROUND OF THE INVENTION

Heat engines such as gas turbine or reciprocating engines are used to generate electrical power for various applications. The heat engines produce hot exhaust gases that can be used to operate heating and cooling equipment. There are several variables in the operation of the heating and cooling systems that make it difficult to combine all of the performance requirements of the system to allow the system to function in the most efficient manner. There is a need in the industry for a method for controlling such a heat engine based electrical power supply system to generate the quantity of exhaust gases necessary to efficiently power the heating and cooling demands of the system. In the past most control systems have concentrated on the requirements for the production of electrical power. The exhaust gases from the heat engines were just byproducts of the electrical power generating demands. Accordingly, there is a need for a control method that operates the system based on the requirements of the heating and cooling equipment in the system.

### SUMMARY OF THE INVENTION

The present invention is directed to a method of controlling power generating equipment to coordinate with the demands of heating equipment and cooling equipment that are powered by exhaust gases from the power generating equipment. A feed-forward prediction is made of the electrical power output that produces substantially the required exhaust gas output, matching the heating and cooling equipment requirements.

A composite power production demand error variable is produced that combines all of the heating and cooling demand requirements that vary from the feed-forward prediction. The demand error variable is sent to a proportional-integral-derivative (PID) control element to generate a control variable. The control variable and the feed-forward prediction are combined to produce a setting for the power generating equipment to produce only the gases required to operate the heating equipment and cooling equipment at the desired level.

It is the objective of the control system that the heating and cooling components be powered by exhaust gases from turbines so that essentially no unused hot exhaust gases are discharged from the system.

Other objects and advantages of the present invention will become apparent to those skilled in the art upon a review of the following detailed description of the preferred embodiments and the accompanying drawings.

### BRIEF DESCRIPTION OF THE DRAWINGS

FIG. 1 is an overall schematic of the method.

FIG. 2 is a detailed schematic illustration of the “Feed-Forward” portion of the method.

FIG. 3 is a detailed schematic illustration of the “Feedback” portion of the method.

FIG. 4 is a combined detailed schematic illustration.

FIG. 5 is a plane view of an apparatus that uses the method of the present invention.

### DETAILED DESCRIPTION OF THE PREFERRED EMBODIMENT(S)

The following describes a method to control a set of heat engines, and separate hot water and chilled water generating devices.

Heat engines that produce electricity turbine also produce a hot exhaust stream. The hot exhaust stream represents useful energy. Heat exchangers may be used to produce warm water for comfort heating of living spaces or other uses from the hot exhaust stream. Chillers of the absorption type may be used to produce chilled water for comfort cooling of living spaces, or other uses, from the hot exhaust stream. The features of the invention will be described using small gas turbines (<500 kW electrical power output) as the heat engine. It should be understood, however, that other heat engines can also be used with the invention.

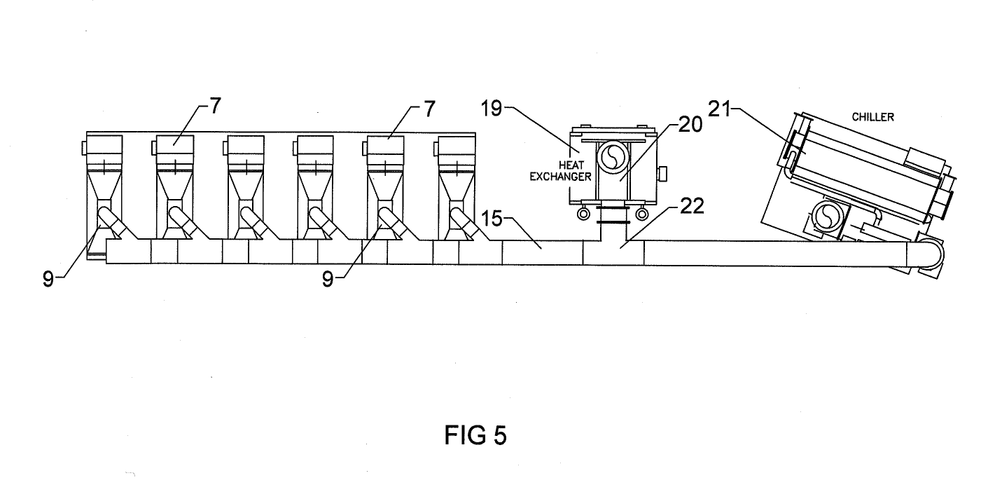

The Tri-Generation system 1 as shown in FIG. 5 includes three sets of components. A plurality of gas turbines 7 powered by natural gas with each turbine having an exhaust outlet 9. The exhaust outlets of each turbine are connected to a common exhaust 15. Heat exchanger 19 is connected to the common exhaust and is powered by turbine exhaust. An absorption chiller 21 is also connected to the common exhaust and is powered by turbine exhaust. For best efficiency, the turbines 7 should be operated to match the thermal requirement. That is, the turbines should produce just enough exhaust to meet the demands of the absorption chiller 21 plus the demands of the heat exchanger 19, but no more. When the chiller 21 is active, its embedded controls modulate a 3-way exhaust valve 22 to admit enough exhaust gas from the common exhaust 15 to meet the chiller's thermal requirement and so to meet its chilled water set-point.

The heat exchanger 19 includes another 3-way exhaust valve 20. This valve operates under the controls for the heat exchanger. Exhaust gas flow from the common exhaust 15 not taken by the chiller is diverted to the 3-way valve 20 on the heat exchanger. The 3-way valve diverts exhaust gas from the turbines 7 either through the heat exchanger to supply the thermal requirements of the heat exchanger, or around the heat exchanger and up a stack to be exhausted to the atmosphere.

The best operating point is to generate the correct exhaust flow to meet both the needs of the thermal chiller, and the heat exchanger, while diverting no unused exhaust gases up the stack.

A typical feedback controller would identify a measurement with a desired set point and employ that as the process variable in a proportional-integrated-derivative (PID) loop. In this case, there is no single process variable that can be used. The goal is to meet the chilled water set point, the hot water set point and to avoid diverting exhaust to the atmosphere.

It is difficult to operate electricity generating equipment in coordination with heating and cooling equipment and match the requirements of heating or cooling a space, at the most efficient setting. The difficulty results from combining measurements of the operation of the different elements in such a way as to efficiently operate the system. The method described is a way to adjust the electric generation equipment to most efficiently match the heating and cooling requirement. Measurements are combined in such a way as to make them compatible with each other so that they can be combined into a single value for efficient operation of the electric generating equipment.

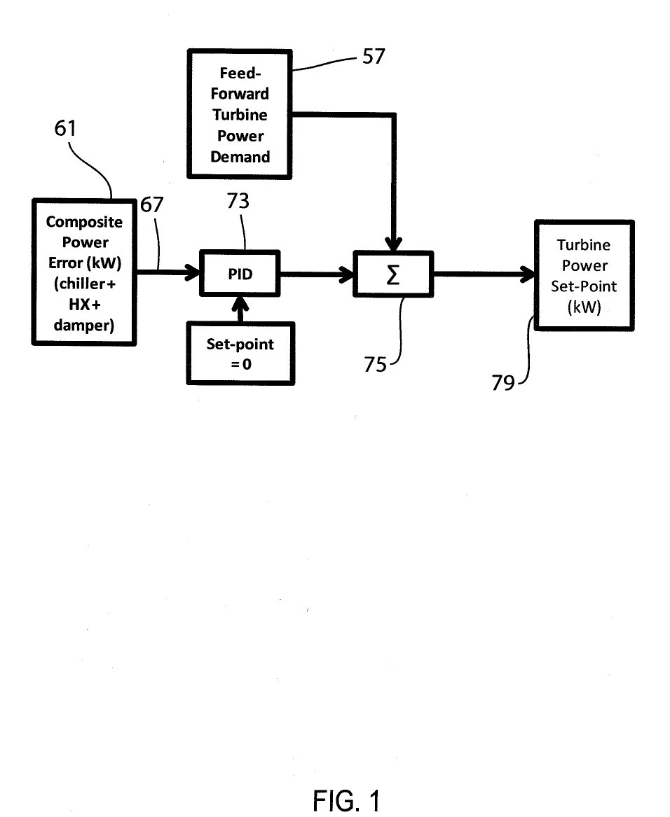

FIG. 1 shows the overall method or system, consisting of two parts. The first part is the prediction of the approximate electric power demand that matches the combined heating and cooling requirement. The prediction is used as a “Feed-Forward” value 57. In general, this prediction will not precisely match the actual power generation requirement. The second part of the method is to produce a composite power production error 61 that combines all of the factors of heating and cooling that represent shortfalls or inefficiency. This composite error is used as the Process Variable (PV) 67 in a Proportional-Integral-Derivative (PID) 73 control element to generate a Control Variable (CV) 75 that is employed to set the power output 79 of the electricity generating equipment 7.

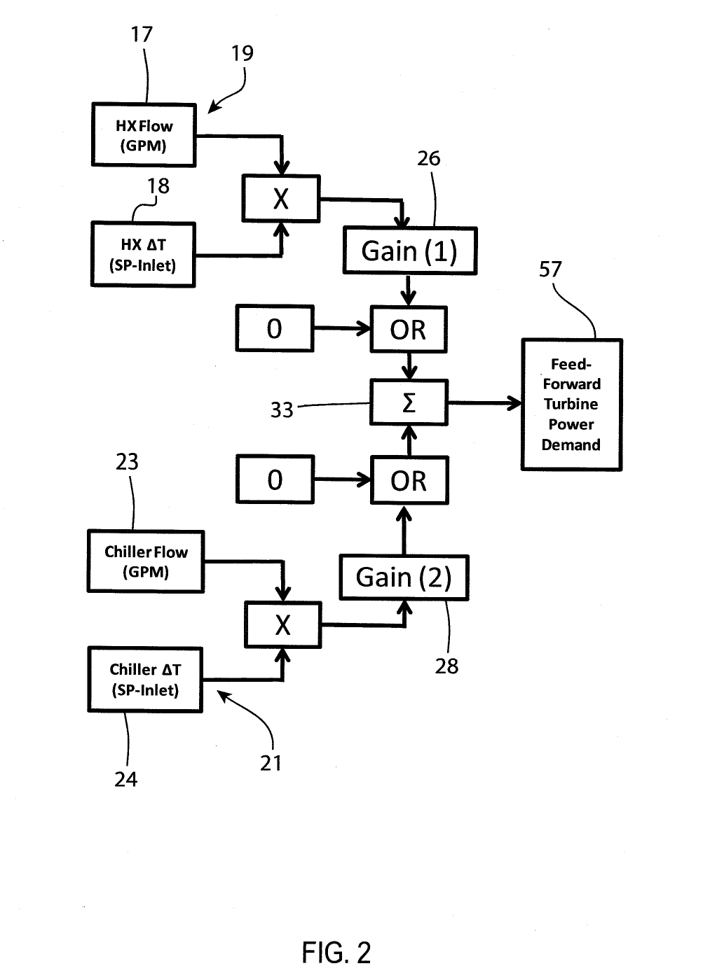

FIG. 2 is a diagram of the method for producing an estimate for setting the power output of the generation equipment or turbines 7. Measurements of flow 17 and temperature 18 of the water heating system 19 and the flow 23 and temperature 24 of the cooling system 21 are combined to calculate the thermal energy demanded by the heating and cooling system, or other thermal systems. These values are scaled by constants (Gains) 26, 28 specific to the heating 19 and cooling 21 equipment and the electricity generating equipment to produce an estimate of the power generation requirement to meet the thermal demand. The values for cooling 21 and heating 19 are summed 33 to produce a total estimate as the feed forward demand value 57. The feed forward demand value is used to establish the initial settings for the turbines to produce a quantity of exhaust gases to approximate the needs of the heating and cooling equipment. The feed forward demand value is normally not the precise value that provides the exact quantity of exhaust gases required. Accordingly, it is necessary to modify the feed forward demand value to have the system operating at its maximum efficiency.

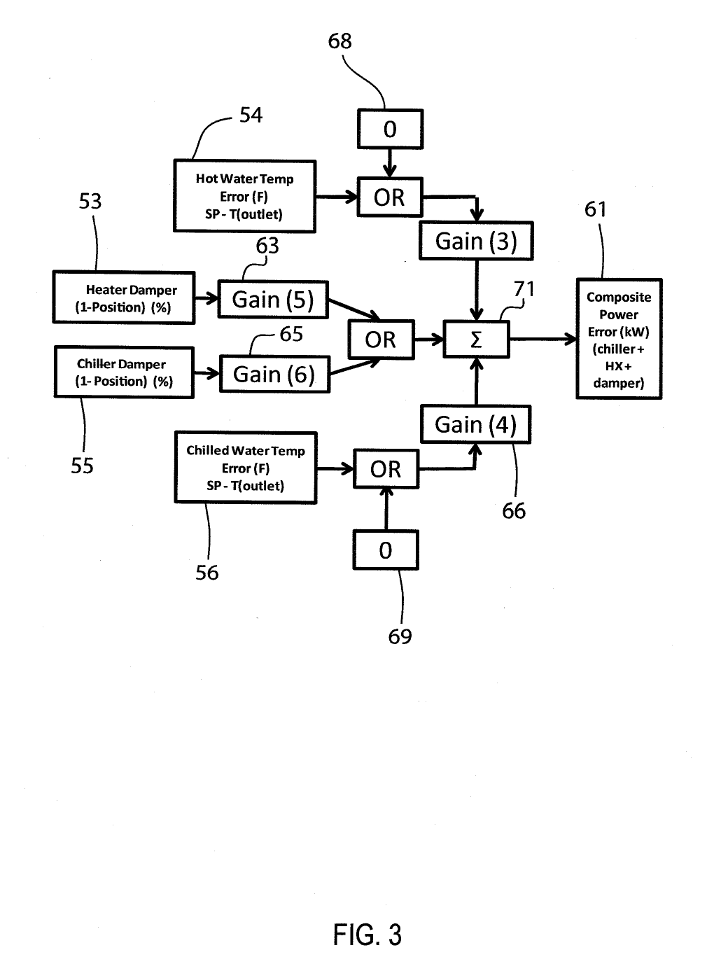

FIG. 3 is a diagram of the method for producing a composite error 61 in the electric power setting that can be used to modify the feed forward demand value. The heating 19 and cooling equipment 21 is designed to operate using hot exhaust gas from the power generating equipment or turbine 7. These components have independent controlling elements such as heat exchanger damper 53 and chiller damper 55. These elements regulate the amount of exhaust gases that are accepted by the units. These controlling elements, by themselves, require that excess exhaust gases be produced, and simply reject energy not required. This operation is inefficient. FIG. 3 illustrates a method to produce a composite error 61 combining both the short-fall and excess exhaust gas requirements from the actual operation of the heating and cooling equipment. Shortfalls are calculated from the difference between the desired quantity of cooling and heating output, or the Set Point (SP) 79, and the actual conditions. Excess exhaust gas production is calculated from the position of the internal controlling element, such as a damper 53, 55, that rejects excess exhaust gas under the control of the independent control of the heating 19 or cooling equipment 21. The difference is established by the hot water or heating error 54 and the chilled water or cooling error 56. This is the difference between the set point 79 and the actual conditions experienced by the demands on the heat exchanger 19 and the chiller 21. If the heat exchanger or the chiller is not being operated there will be no shortfall or excess valve imputed into the system. This is reflected by the heating off 68 and cooling off 69 values of zero when these components are not being utilized. These values are scaled by constants (Gains) 63, 64, 65, 66 specific to the heating and cooling equipment and the electricity generating equipment 7 to produce a value for the error in the current power generation setting. The gains are such that the individual error values are compatible with each other and may be summed 71. Further they are compatible with the feed-forward estimate of the previous paragraph.

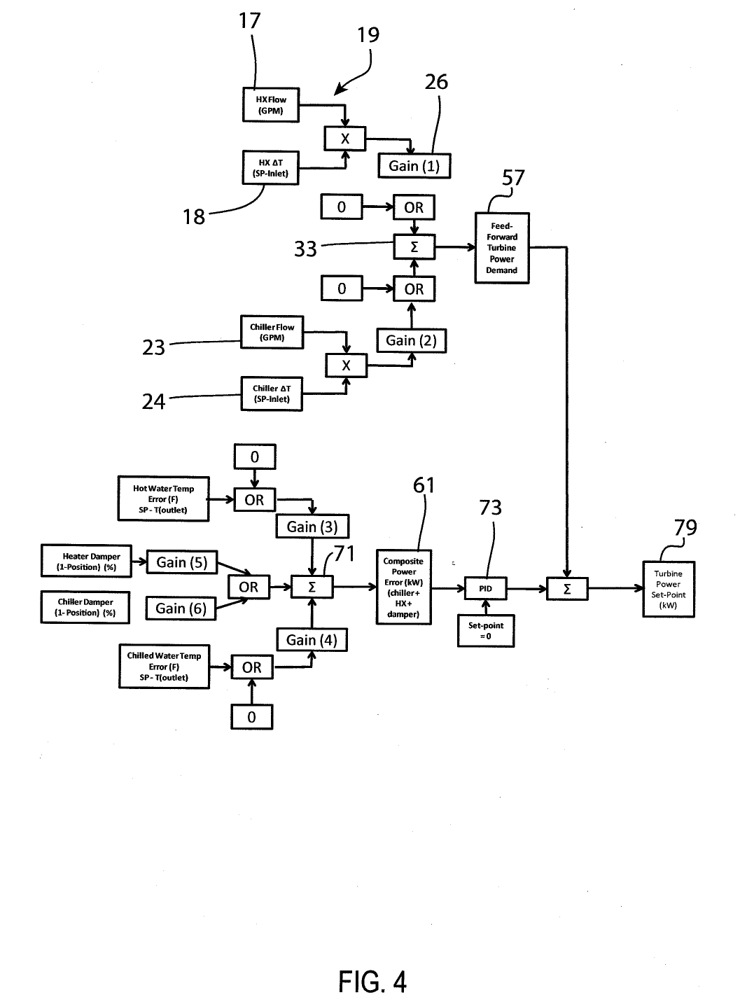

FIG. 4 shows the combination of these elements using a PID 73 control element 73 to produce a setting or set point 79 for the power generating equipment.

To achieve all three goals of chilled water set point, hot water set point and zero exhaust gas diverted to the atmosphere, it is necessary to define a composite process variable that achieves all three objectives. This process is illustrated in FIG. 3. Since each of the three components is of a different character, each is multiplied by a separate factor (Gain) 63-66, then summed to arrive at the composite. The composite process variable is in the form of an “error”. The goal of the feedback loop shown in FIG. 3 is to control the process to achieve zero “composite” error.

Since the error signals are summed 71 and since they are different character, they should be weighted to place them on a common standing.

Individual gain factors allow this normalization. One way to accomplish this is to consider the control authority of each element. Consider the example of operation of turbines that produce 390 kW of electrical power at full power. The example of the turbines that produce 390 kw of electrical power is given only for the sake of explanation. The turbines can produce various levels of electrical power, but a specific power level was selected to provide a basis to explain the operation of the control system. Further, consider an operating condition with half of the exhaust going to the heat exchanger 19 and half going to the chiller 21. If the heat exchanger has a hot water rise of 20 degrees for the 195 kW consumed, the heat exchanger requires 9.75 kW per degree of rise. If the chiller has 10 degrees of temperature drop for the same power or the chiller requires −19.5kW per degree (negative since increased power reduces the outlet temperature). Lastly since the damper position ranges from 0 to 100%, it controls 1.95 kW per percent of movement. Note the signs on the gain terms are important to properly evaluate the variables in the control process. The error is defined as the set point minus the process variable (the outlet temperature).

If the hot water temperature is one degree above the set point the turbines are producing about 9.75 kW too much power. If the chilled water is 1 degree above the set point the turbines are producing 19.5 kW too little power. If the damper position is open 1% to divert exhaust to the stack the turbines are producing 1.95 kW too much power; the damper set point being zero.

Control system performance can be improved by combining the feedback (or closed-loop) control 61 of a PID controller 73 with feed-forward (or open-loop) control 57. Knowledge about the system (such as the required exhaust power) can be fed forward and combined with the output of a feedback controller to improve the overall system performance. The feed-forward value alone may provide the major portion of the controller output. The PID controller can be used primarily to respond to whatever difference or error remains between the set point (SP) and the actual value of the process variable (PV). Since the feed-forward output is not affected by the process feedback, it improves the system response and stability.

In the case of the chiller 21 and the heat exchanger 19, an estimate of the desired power level for the turbines 7 can be derived. The power demand can be estimated from the thermal energy being requested from the heat exchanger and the chiller. The power demand is the product of the water flow rate and the difference between the inlet and set point temperatures, times appropriate energy conversion efficiencies. Consider the example of turbines operating at 390 kW (6 times 65 kW), expected to produce a 20° F. rise in the hot water at a flow of 240 GPM. Similarly consider a chiller expected to produce a 10 degree drop in the chilled water at a flow of 371 GPM. The feed-forward gains are thus 0.081 kW/GPM-F for the heat exchanger, and −0.11 kW/GPM-F for the chiller. Note the chiller naturally acts opposite the heat exchanger as increased power reduces the outlet temperature.

It's anticipated that feed-forward portion of the controller alone will provide the major portion of the controller output. If the feed-forward signal proves reasonably accurate, the feedback portion of the control will only have to address a relatively small error in the process variable.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

We claim:

1. Method of controlling power generating equipment to coordinate with the demands of heating equipment and cooling equipment that are powered by exhaust gases from the power generating equipment comprising:
producing a feed-forward prediction of the electrical power supply that produces substantially the required exhaust gas output to match the heating and cooling equipment requirements;
producing a composite power production demand error variable that combines all of the heating and cooling demand requirements that vary from the feed-forward prediction;
sending the variable to a proportional integral derivative control element to generate a control variable combining the control variable and the feed-forward prediction to produce a setting for the power generating equipment to produce essentially only the gases required to operate the heating equipment and cooling equipment at the desired level.

2. The method of claim 1 in which powering of the heating and cooling equipment is accomplished by a plurality of power generating equipment, the plurality of power generating equipment producing power and the exhaust gases required to operate the heating and cooling equipment.

3. The method of claim 2 in which the plurality of power generating equipment have an exhaust gas outlet and the exhaust gas outlets for each power generating equipment is connected to a common exhaust, the common exhaust being operatively connected to the heating and cooling equipment.

4. The method of claim 3 in which the exhaust gas outlet for each of the plurality of power generating equipment have a controller for directing exhaust gases to the common exhaust only when the power generating equipment is operating.

5. The method of claim 4 in which the controller prevents exhaust gases in the common exhaust from entering power generating equipment that is not operating.

6. The method of claim 1 in which the feed-forward prediction is established by measuring the flow and temperature of the heating equipment and the cooling equipment, sealing the measurements, combining the sealed measurements of the heating and cooling equipment to produce an estimate of the level of operation of the power generation equipment to produce the approximate level of exhaust gases to meet the requirements of the heating and cooling equipment.

7. The method of claim 6 in which the power production demand error variable is established by monitoring the difference between the feet-forward prediction for the exhaust gases required by the heating and cooling equipment and the actual exhaust gas requirements for the heating and cooling equipment to produce an actual value, calculating the excess of exhaust gases produced by the power generating equipment, scaling the differences between the actual value and the excess of exhaust gases, combining the actual value and the excess exhaust gases to produce an error value.

8. The method of claim 7 in which the error value is used to produce the composite power production demand error variable for the proportional integral derivative control element.
